(19) United States
(12) Patent Application Publication
(10) Pub. No.: US 2016/0233927 A1
(43) Pub. Date: Aug. 11, 2016

(54) UNIDIRECTIONAL INDUCTION TYPE NEAR FIELD COMMUNICATION DEVICE

(71) Applicant: WINSO TECHNOLOGY COMPANY LIMITED, Taichung City (TW)

(72) Inventor: Tse-Jen Wu, Taichung City (TW)

(21) Appl. No.: 14/619,552

(22) Filed: Feb. 11, 2015

(51) Int. Cl. H04B 5/00; H01Q 1/22; H01Q 7/00

(52) U.S. Cl. CPC H04B 5/0075; H01Q 7/00; H01Q 1/22

(57) ABSTRACT

A unidirectional induction type near field communication device includes an induction layer having an IC chip embedded therein and an induction coil located on a front surface thereof, a wave-absorbing layer of laminated structure made of a mixture of polyester and a high-permeability metal material and bonded to a back surface of the induction layer opposite to the induction coil, and a metal barrier layer bonded to one side of the wave-absorbing layer opposite to the induction layer for enabling the induction layer to achieve a unidirectional NFC based wireless communication with an external mobile electronic device.

### BACKGROUND OF THE INVENTION

1. Field of the Invention

The present invention relates to wireless communication technology and more particularly, to a unidirectional induction type near field communication device, which comprises an induction layer having an induction coil located on a front side thereof, a wave-absorbing layer bonded to an opposing back side of the induction layer, and a metal barrier layer bonded to the wave-absorbing layer opposite to the induction layer to ensure unidirectional induction.

2. Description of the Related Art

With the rapid development of electronic technology, many electronic products have been created and widely used in our daily life, bringing convenience our life, work and school, etc. Due to rapid growth of 3C products in recent years, smart phones, tablet computers and other mobile electronic devices have become indispensable tools for people. Many related peripheral devices (such as earphones, speakers, Bluetooth devices, etc.) and application software and systems are then created, promoting rapid development of wireless communication technology. The most commonly used wireless transmission methods, such as radio frequency (RF), Bluetooth, or near field communication, etc. enable computer network communication via short-range wireless signals, facilitating wireless transmission of a variety of electronic signals (such as text, pictures, video, audio and scanned images, etc.). The application of a wireless communication technology enables people to get the desired information and data from the web by means of a smart phone, tablet computer or other mobile electronic devices at anytime and anywhere where the applied wireless signal can reach, breaking through time and geographic restrictions. Thus, wireless transmission has become the most convenient and fastest mode of communication. In the modern society, people, whether male, female, old or young are quite fond of this wireless communication mode. Nowadays, people can use a smart phone, tablet computer or other mobile electronic device to connect to the Internet in a wireless manner for downloading data and performing a variety of electronic applications. Thus, the use of a wireless communication technology enables a mobile electronic device to provide dynamic audio and video modes for more active, more diversified use and applications. You can see many people in a public place bowing the head and putting a finger on the touchscreen of a smart phone, tablet computer or other mobile electronic device and sliding the finger on the touchscreen. This phenomenon has become an important part of the daily life of modern people.

In addition to the transmission of electronic data signals, electronic technology has also been applied in the field of teaching reading. By means of printing a predetermined text, image or QR code on the surface of a book and using a specially designed pen scanner to scan the text, image or QR code for processing by an internal circuit system, the pen scanner can read out a predetermined voice content or perform a teaching mode relating the text, image or QR code. This sound teaching manner is helpful for self-directed learning activities and widely invited in recent years. This self-learning mode has been introduced into many schools. However, a scan-based voice teaching mode is a simple teaching mode of voice-vs-still book image that repeats the same voice reading. This self-learning mode can lose its attraction to people after a certain period of time in use. Further, the pen scanner-based voice teaching mode can simply give voice without dynamic images, and therefore, making it impossible to achieve interactive dynamic video teaching to attract people. In general, scanner-based voice teaching mode and book-based voice teaching mode are monotonous and have drawbacks. Improvement in this regard is desired.

### SUMMARY OF THE INVENTION

The present invention has been accomplished under the circumstances in view. It is therefore the main object and other object of the present invention to provide a unidirectional induction type near field communication device comprises an induction layer having an IC chip embedded therein and an induction coil located on a front surface thereof and electrically coupled to the IC chip, a wave-absorbing layer of laminated structure made of a mixture of polyester and a high-permeability metal material and bonded to a back surface of the induction layer opposite to the induction coil, and a metal barrier layer bonded to one side of the wave-absorbing layer opposite to the induction layer for enabling the induction layer to achieve a unidirectional NFC based wireless communication with an external mobile electronic device.

When approaching a mobile electronic device (such as smart phone or tablet computer) to the induction coil of the induction layer, a NFC-based wireless communication is established between the mobile electronic device and the IC chip of the induction layer for performing a dynamic audio and video application mode via the Internet. During operation, the wave-absorbing layer absorbs generated electromagnetic waves, and the metal barrier layer prevents diffusion of electromagnetic waves of the NFC signal and restricts the NFC-based wireless communication in one direction.

After the induction layer, the wave-absorbing layer and the metal barrier layer are bonded together, the unidirectional induction type near field communication device has a sheet-like structure for embedding in one single page or an inner surface of a front cover or back cover of a book for unidirectional induction. Further, two unidirectional induction type near field communication devices can be embedded in one single page of a book in reversed directions for near field communication with an external mobile electronic device in two directions without causing interference.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of a unidirectional induction type near field communication device in accordance with the present invention.

FIG. 2 is an exploded view of the unidirectional induction type near field communication device in accordance with the present invention.

FIG. 3 is a schematic drawing illustrating an application example of the unidirectional induction type near field communication device in accordance with the present invention.

FIG. 4 is a schematic drawing illustrating another application example of the unidirectional induction type near field communication device in accordance with the present invention.

FIG. 5 is a schematic drawing illustrating still another application example of the unidirectional induction type near field communication device in accordance with the present invention.

### DETAILED DESCRIPTION OF THE PREFERRED EMBODIMENT

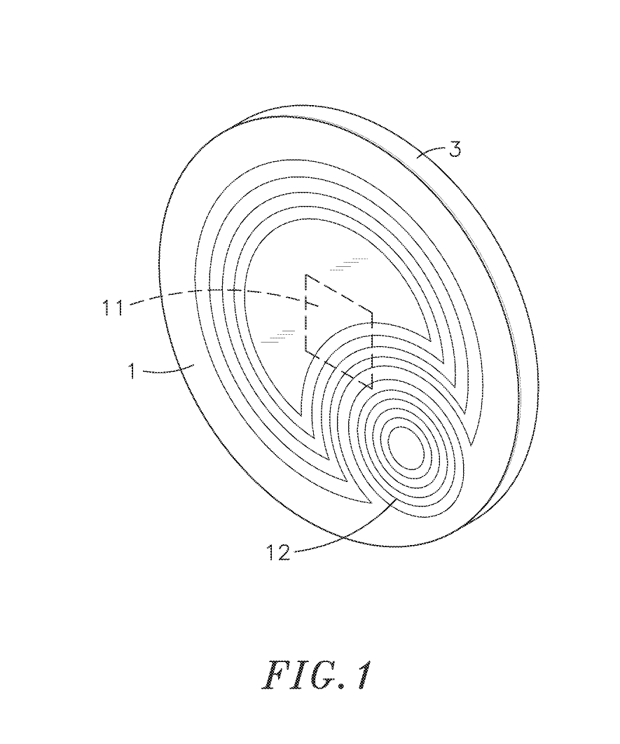

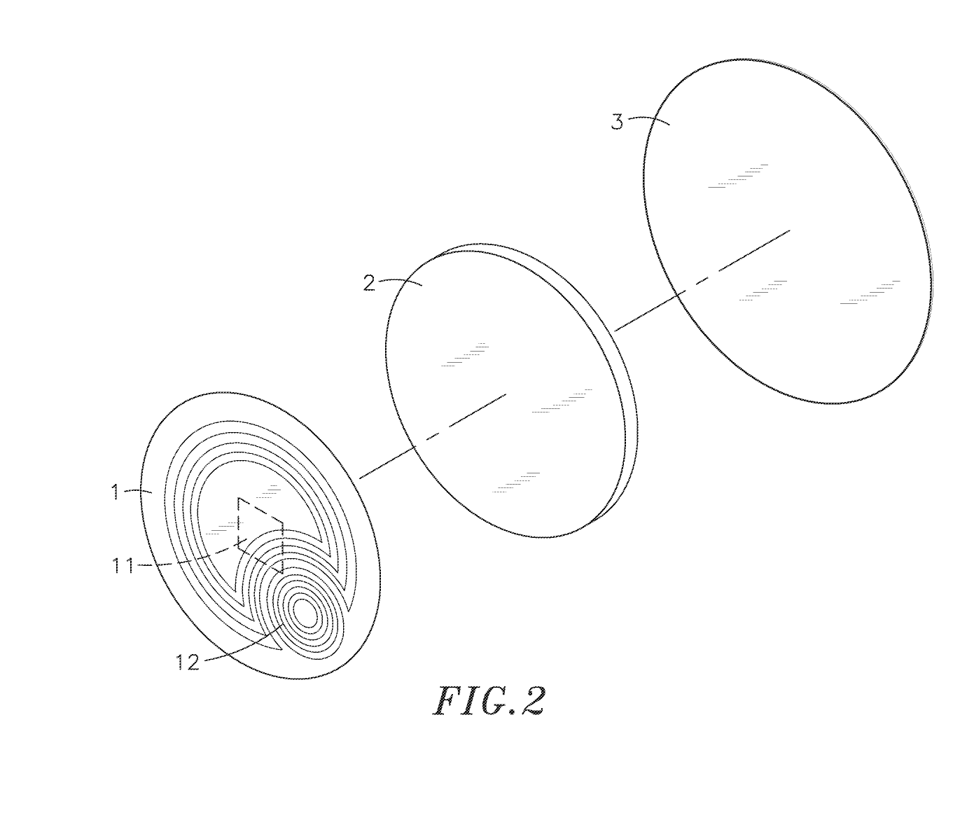

Referring to FIGS. 1 and 2, a unidirectional induction type near field communication device in accordance with the present invention is shown. The unidirectional induction type near field communication device comprises an induction layer 1, a wave-absorbing layer 2, and a metal barrier layer 3.

The induction layer 1 comprises an IC chip 11 embedded therein, and an induction coil 12 located on one side, namely, the front surface thereof and electrically coupled to the IC chip 11.

The wave-absorbing layer 2 has a laminated structure made of a mixture of polyester and a high-permeability metal material.

The metal barrier layer 3 is made from copper, ferrite, aluminum or tin, or any of their alloys.

In fabrication, the wave-absorbing layer 2 is bonded between the induction layer 1 and the metal barrier layer 3 with an adhesive, resin, or double-sided adhesive tape, keeping the induction coil 12 of the induction layer 1 at an outer side opposite to the wave-absorbing layer 2. After the induction layer 1, the wave-absorbing layer 2 and the metal barrier layer 3 are bonded together, a thin sheet of unidirectional induction type near field communication device is obtained.

The embedded IC chip 11 of the aforesaid induction layer 1 is adapted for storing data (such as text, pictures, video, sound or scanned images, etc.). Through the induction coil 12, the unidirectional induction type near field communication device can perform near field communications (NFCs) with an external mobile electronic device (such as smart phone or tablet computer) in a unidirectional manner. A wireless communication can be established between an external mobile electronic device and the unidirectional induction type near field communication device only when the external mobile electronic device is brought into proximity with the induction coil 12 of the induction layer 1. However, approaching an external mobile electronic device to the metal barrier layer 3 cannot establish a wireless communication between the external mobile electronic device and the unidirectional induction type near field communication device. Further, the wave-absorbing layer 2 is bonded to an opposing back surface of the induction layer 1 opposite to the induction coil 12 for absorbing electromagnetic waves of wireless communication signals; the metal barrier layer 3 is bonded to the back side of the wave-absorbing layer 2 opposite to the induction layer 1 to provide a shielding effect, preventing diffusion of electromagnetic waves of the NFC signal and restricting the NFC-based wireless communication in one single direction. Because the metal barrier layer 3 can interfere with the induction signal of the induction layer 1, leading to a failure in reading signal from the induction layer 1 by an external mobile electronic device. The arrangement of the wave-absorbing layer 2 between the induction layer 1 and the metal barrier layer 3 prohibit the induction layer 1 from being interfered by the metal barrier layer 3, ensuring unidirectional induction.

Further, the surface area of the metal barrier layer 3 can be larger than or equal to the surface area of the wave-absorbing layer 2 so that the metal barrier layer 3 can be bonded to the whole back surface area of the wave-absorbing layer 2 to shield the wave-absorbing layer 2 against electromagnetic waves or other noises, providing the induction layer 1 and the wave-absorbing layer 2 with a good shielding effect, and thus, the near field communication device formed of the induction layer 1, the wave-absorbing layer 2 and the metal barrier layer 3 is practical for unidirectional NFC based wireless communication with an external mobile electronic device.

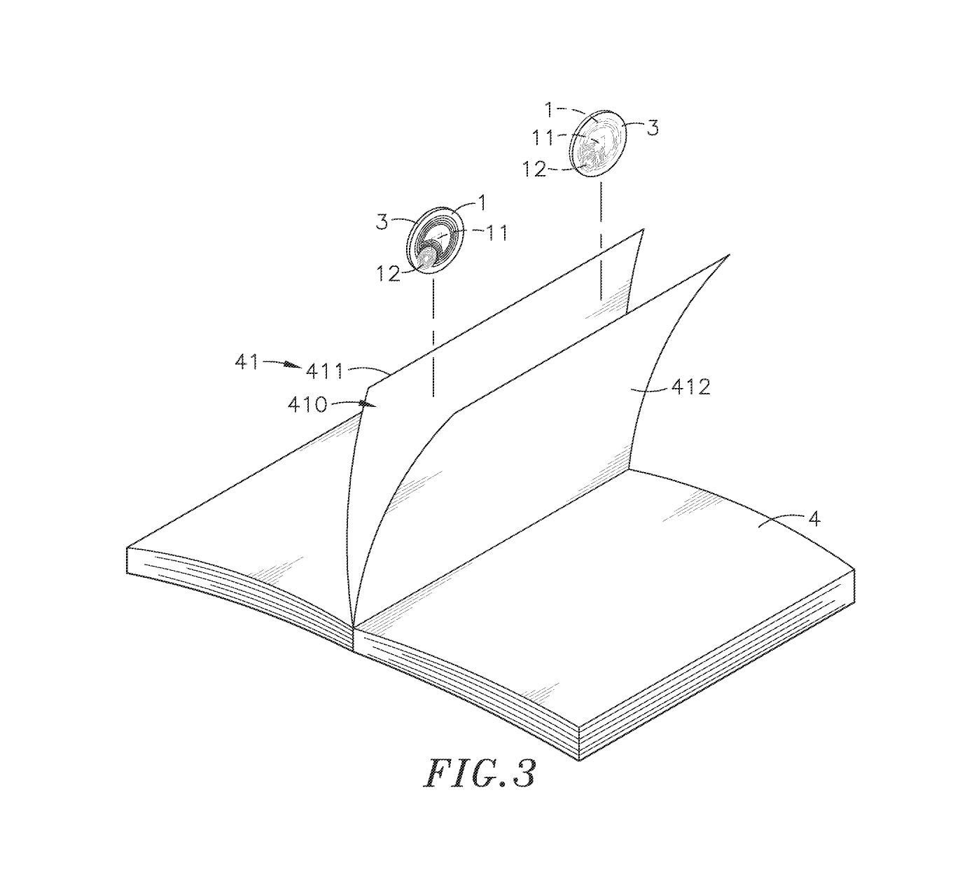

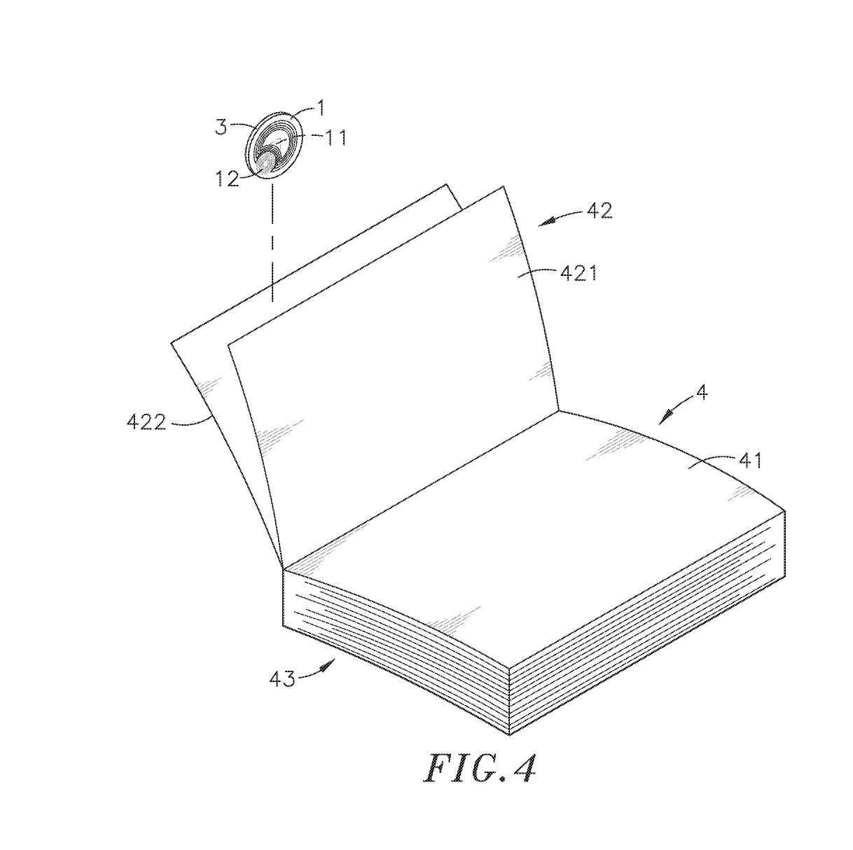

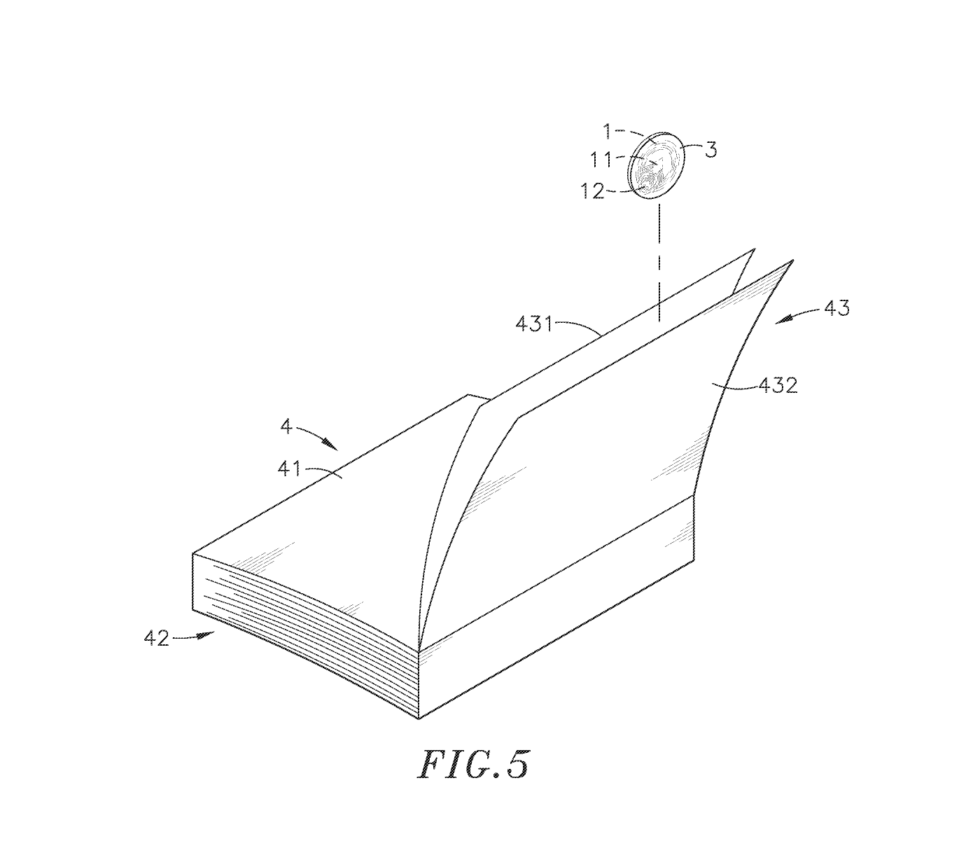

Referring to FIGS. 3-5, and FIGS. 1 and 2 again, two unidirectional induction type near field communication devices can be embedded in the secret compartment 410 of one leaf of paper 41 of the book 4 at different locations in reversed directions to keep the induction coil 12 of the induction layer 1 of one unidirectional induction type near field communication device face toward the left-hand page 411 of one leaf of paper 41 of the book 4 and the other unidirectional induction type near field communication device face toward the right-hand page 412 of the same leaf of paper 41 for unidirectional NFC based wireless communication with an external mobile electronic device (such as smart phone or tablet computer) exclusively in one direction. Further, the IC chip 11 of the induction layer 1 has stored therein a text, picture, video, audio, or scanned image or QR code relating to the content of the left-hand page 411 or right-hand page 412. When approached a mobile electronic device to the induction coil 12 of the induction layer 1 that faces toward the left-hand page 411 or right-hand page 412, the mobile electronic device can than run a predetermined application software or operating system to perform an interactive dynamic video teaching program relating the content of the left-hand page 411 or right-hand page 412 via the internet. This, interactive learning function can effectively attract users interest, and the user will not easily feel tired. Further, the unidirectional induction characteristic of the unidirectional induction type near field communication device prevents a mobile electronic device from getting data relating to the content of a different page, i.e., approaching a mobile electronic device to the induction coil 12 of the induction layer 1 that faces toward the left-hand page 411 of one leaf of paper 41 of the book 4 can simply read in the content of the left-hand page 411 (such as lion and other animals), and is prohibited from reading in the content of the right-hand page 412 of the same leaf of paper 41. Thus, the invention effectively prevents a mobile electronic device from getting the data content of a wrong page. Further, as shown in FIGS. 4 and 5, two unidirectional induction type near field communication devices can be respectively embedded in between the inner face layer 421 and outer face layer 422 of the front cover 42 and the inner face layer 431 and outer face layer 432 of the back cover 43 of the book 4 for unidirectional induction. Before unsealing the book 4, any person cannot establish communication between an external mobile electronic device and the unidirectional induction type near field communication device in the front cover 42 of the book 4 or the unidirectional induction type near field communication device in the back cover 43 of the book 4 to read in the related information of the book 4 (directory, author, publisher or description, etc.), maintaining book confidentiality.

Because a wireless communication can be established only when approaching an external mobile electronic device to the induction coil 12 of the induction layer 1 and because the metal barrier layer 3 provides a shielding effect to prohibit transmission of a wireless signal therethrough, after embedded a unidirectional induction type near field communication device of the present invention in the secret compartment 410 of one leaf of paper 41 of the book 4, a mobile electronic device, after established communication with the embedded unidirectional induction type near field communication device, the mobile electronic device can simply read in data relating to the content of the left-hand page 411 (or right-hand page 412). By means of the unidirectional induction characteristic, the unidirectional induction type near field communication device is practical for use in a book, document, brochure, catalog, etc. for unidirectional single page induction.

In conclusion, the invention provides a unidirectional induction type near field communication device comprising an induction layer 1 having an IC chip 11 embedded therein and an induction coil 12 located on a front side thereof, a wave-absorbing layer 2 bonded to an opposing back side of the induction layer 1 opposite to the induction coil 12 for absorbing electromagnetic waves, and a metal barrier layer 3 bonded to a back side of the wave-absorbing layer 2 opposite to the induction layer 1 to provide a shielding effect. The near field communication device can be embedded in a secret compartment 410 of a leaf of paper 41 of a book 4 between a left-hand page 411 and a right-hand page 412 with the induction coil 12 of the induction layer 1 facing toward the left-hand page 411 or right-hand page 412 for unidirectional NFC based wireless communication with an external mobile electronic device to perform a dynamic audio and video playing function via the Internet.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A unidirectional induction type near field communication device, comprising:
an induction layer comprising opposing front surface and back surface, an IC chip embedded therein between said front surface and said back surface, and an induction coil located on said front surface and electrically coupled to said IC chip;
a wave-absorbing layer of laminated structure made of a mixture of polyester and a high-permeability metal material and bonded to said back surface of said induction layer; and
a metal barrier layer bonded to one side of said wave-absorbing layer opposite to said induction layer.

2. The unidirectional induction type near field communication device as claimed in claim 1, wherein said induction layer, said wave-absorbing layer and said metal barrier layer are bonded together with selectively an adhesive, resin, or double-sided adhesive tape.

3. The unidirectional induction type near field communication device as claimed in claim 1, wherein the surface area of said metal barrier layer is larger than or equal to the surface area of said wave-absorbing layer.

4. The unidirectional induction type near field communication device as claimed in claim 1, wherein said induction layer, said wave-absorbing layer and said metal barrier layer are bonded together to form a sheet-like structure for embedding in one leaf of paper in a book for unidirectional induction.

5. The unidirectional induction type near field communication device as claimed in claim 1, wherein said induction layer, said wave-absorbing layer and said metal barrier layer are bonded together to form a sheet-like structure for embedding in a back surface of a front cover or back cover of a book.
